(19) United States
(12) Patent Application Publication
(10) Pub. No.: US 2005/0008770 A1
(43) Pub. Date: Jan. 13, 2005

(54) Method of manufacturing color filter substrate, method of manufacturing electroluminescent substrate, electro-optical device and method of manufacturing the same, and electronic apparatus and method of manufacturing the same

(76) Inventor: Tomomi Kawase, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/859,449

(22) Filed: Jun. 2, 2004

(30) Foreign Application Priority Data
Jun. 2, 2003 (JP) 2003-156835

(51) Int. Cl. B05D 5/12

(52) U.S. Cl. 427/66; 427/162

(57) ABSTRACT

A method of manufacturing a color filter substrate is provided. The method includes a step of forming banks, by which a plurality of display dot regions are formed on a base member, and a step of discharging a liquid filter material from nozzles to the plurality of display dot regions as liquid drops. In the step of discharging the material, the centers of the liquid drops of the filter material are situated within a distance which amounts to about 30% of the distance between the center of the display dot region and the edge of the display dot region closest to the center thereof. Therefore, it is possible to prevent the discharged liquid drops from invading adjacent display dot regions over the banks.

### RELATED APPLICATIONS

This application claims priority to Japanese Patent Application No. 2003-156835 filed Jun. 2, 2003 which is hereby expressly incorporated by reference herein in its entirety.

### BACKGROUND

1. Technical Field of the Invention

The present invention relates to a method of manufacturing a color filter substrate used for performing color display. The present invention also relates to a method of manufacturing an electroluminescent substrate in which light-emitting elements are formed on a substrate. The present invention also relates to an electro-optical device, such as a liquid crystal device or an electroluminescent device, and to a method of. manufacturing the same. The present invention also relates to an electronic apparatus, such as a mobile telephone, a portable information terminal, and a personal digital assistant (PDA), and to a method of manufacturing the same.

2. Description of the Related Art

Electro-optical devices, such as liquid crystal devices and electroluminescent devices, are widely used for electronic apparatuses such as mobile telephones, portable information terminals, and personal digital assistants (PDA). For example, the electro-optical devices are used for visually displaying various information items relating to the electronic apparatuses.

In a case where a liquid crystal device is used as an electro-optical device, when color display is performed by the liquid crystal device, a color filter substrate is provided in the liquid crystal device. The color filter substrate is manufactured by forming color filters on a base member composed of transmissive glass. The color filters are optical components obtained by arranging the filter components of the three colors R (red), G (green), and B (blue) or the filter components of the three colors C (cyan), M (magenta), and Y (yellow) in a predetermined arrangement in plan view.

When an electroluminescent device is used as an electro-optical device, an electroluminescent substrate is commonly provided in the electroluminescent device. The electroluminescent substrate is formed by arranging a plurality of light-emitting elements on a base member composed of transmissive glass in a matrix.

When the color filter substrate is manufactured by forming the color filters on the base member, that is, when the plurality of filter components are formed on the base member, a conventional method of supplying the material of the filter components onto the base member using an inkjet technology has been used (for example, see Japanese Unexamined Patent Application Publication No. 2002-372614). According to this method, dividing components referred to as banks are formed on a base member to divide the substrate into a plurality of regions, and a filter material is discharged from nozzles as liquid drops and is supplied to the regions. Then, the liquid drops are dried to evaporate a solvent included therein, thereby forming the desired filter components.

According to a conventional method of manufacturing a color filter substrate, it is not considered at which position in each desired region the liquid drops of the filter material land. Actually, the landing positions of the liquid drops vary in each region. In this case, when the landing positions of the discharged liquid drops are around the borders of the regions, the discharged material invades adjacent regions over the banks and is mixed with the filter materials of other colors, thereby possibly deteriorating the quality of the color filters.

The present invention is designed to solve the above problems, and it is an object of the present invention to prevent the generation of a mixed color between filter components on a color filter substrate or between light-emitting elements on an electroluminescent substrate when the color filter substrate or the electroluminescent substrate is formed by a liquid drop discharging technology.

### SUMMARY

To achieve the above object, a method of manufacturing a color filter substrate according to the present invention comprises a step of forming dividing components for dividing a base member into a plurality of display dot regions; and a material discharging step of discharging a liquid filter material from a liquid drop discharging portion to the plurality of display dot regions as liquid drops, wherein, in the material discharging step, the liquid drops of the filter material are discharged such that their centers are situated within a distance that amounts to about 30% of the distance between the center of the display dot region and the edge, of the display dot region closest to the center of the display dot region.

According to the above structure, the ‘base member’ is composed of, for example, transmissive glass or transmissive plastic. Furthermore, the ‘dividing component’ is composed of a bank protruding above the substrate or an ink repellent layer formed on the substrate. The ink repellent layer may be formed so as not to protrude above the base member. The bank protrudes above the substrate to thus prevent the flow of a liquid filter material on the surface of the base member. Furthermore, the ink repellent layer prevents the flow of the liquid filter material on the surface of the base member by an ink repelling property.

The filter material is composed of materials of R (red), G (green), and B (blue) or C (cyan), M (magenta), and Y (yellow) colors. The filter material is not limited to special materials, however, it may consist of pigments of various colors made of a transparent material such as resin and a liquid material composed of a glycol-based solvent such as ethylene glycol. Also, the filter material may be a liquid material obtained by dissolving a solid body composed of a pigment, a surface-active agent, and a solvent in an appropriate solvent.

A material of a color selected from the three colors, R, G, and B or a material of a color selected from the three colors, C, M, and Y is supplied to each of the plurality of display dot regions. A pixel is formed of a set of three display dot regions R, G, and B or a set of three display dot regions C, M, and Y.

Furthermore, the ‘step of discharging the filter material as liquid drops’ can be performed by a liquid drop discharging technology, that is, by an inkjet technology. According to the inkjet technology, piezoelectric elements and nozzles are preferably provided in an ink storage chamber, and ink, that is, a liquid material is preferably discharged from the nozzles as liquid drops according to a change in the volume of the ink storage chamber due to the vibration of the piezoelectric elements. In addition, according to the inkjet technology, the ink may be discharged from the nozzles as the liquid drops by expanding the ink stored in the ink storage chamber by heating. Furthermore, the ‘liquid drop discharging portion’ used in the material discharging step includes minute apertures such as the nozzles of an inkjet head.

According to a method of manufacturing a color filter substrate of the present invention, which has the above structure, in one display dot region, it is possible to prevent the liquid drop supplied to the region from landing around the border of the corresponding display dot region, that is, around the dividing component such as the bank and to thus prevent the discharged liquid drop from invading adjacent display dot regions over the dividing components. As a result, it is possible to prevent the generation of a mixed color between the filter components formed in display dot regions adjacent to each other.

Furthermore, in a method of manufacturing a color filter substrate according to the present invention, preferably, a plurality of liquid drops are supplied to each of the plurality of display dot regions. At that time, preferably, the liquid drops are supplied such that their centers are situated within a distance that amounts to about 30% of the distance between the center of the display dot region and the edge of the display dot region closest to the center of the display dot region. Therefore, it is possible to supply a sufficient amount of filter material to each display dot region and to prevent the generation of a mixed color between display dot regions adjacent to each other.

According to the method of manufacturing the color filter substrate in accordance with the present invention, the liquid drop covers the entire display dot region.

According to the method of manufacturing the color filter substrate in accordance with the present invention the dividing components are preferably made of a lyophobic material.

The ‘liquid repellency’ of the lyophobic material is a property of repelling liquid. When the dividing component has a liquid repellent property, the probability of liquid drops going over the corresponding dividing component is small. Therefore, it is possible to prevent the generation of a mixed color between display dot regions adjacent to each other.

According to the method of manufacturing the color filter substrate of the present invention, when the length in the display dot region is L and the width is S, the following relationship preferably holds between L and S.
0.7L≦S≦L

The relationship means that the display dot region is more preferably square than long and narrow (rectangular or ellipsoidal) in shape.

According to the present invention, the filter material tends to be intensively discharged to the center of one display dot region. Therefore, in order to have the discharged filter material uniformly dispersed into the display dot region, the corresponding display dot region is more preferably square than long and narrow in plan view.

Furthermore, according to the method of manufacturing the color filter substrate of the present invention, the display dot region is circular or elliptical in plan view. Therefore, it is possible to uniformly disperse the discharged liquid material in the display dot region.

According to the method of manufacturing the color filter substrate of the present invention, preferably, the filter components formed in the plurality of display dot regions are aligned in a delta arrangement. The delta arrangement is illustrated in FIG. 4(c). To be specific, the filter components having the colors R, G, and B are arranged in the apexes of a triangle, and the filter components having the colors R, G, and B are sequentially and repeatedly arranged in a row.

As a method of arranging a plurality of filter components, the stripe arrangement illustrated in FIG. 4(a) or the mosaic arrangement illustrated in FIG. 4(b) may be used in addition to the delta arrangement. In the stripe arrangement, the filter components having the respective colors R, G, and B are arranged in a column, and the filter components having the colors R, G, and B are sequentially and repeatedly arranged in a row. In the mosaic arrangement, the filter components having the colors R, G, and B are sequentially and repeatedly arranged both in a column and in a row.

In the stripe arrangement and the mosaic arrangement, each filter component tends to belong and narrow. In the delta arrangement, each filter component tends to be close to a square. As mentioned above, when it is intended to uniformly disperse the filter material in the display dot region, the display dot region is more preferably square than rectangular in shape. In this point of view, the delta arrangement is preferably used as the method of arranging the filter material.

A method of manufacturing an electroluminescent substrate according to the present invention comprises a step of forming dividing components for dividing a base member into a plurality of display dot regions; and a material discharging step of discharging a liquid light-emitting material from a liquid drop discharging portion to the plurality of display dot regions as liquid drops, wherein, in the material discharging step, the liquid drops of the filter material are discharged such that their centers are situated within a distance which amounts to about 30% of the distance between the center of the display dot region and the edge of the display dot region closest to the center of the display dot region. Among the respective components of the electroluminescent substrate, since the same components as those of the aforementioned color filter substrate have the same functions, the description thereof will be omitted.

According to the method of manufacturing the electroluminescent substrate of the present invention having the above structure, in the case of one display dot region, it is possible to prevent the liquid drop supplied to the region from being situated around the border of the corresponding display dot region, that is, around the dividing components such as the banks, and thus to prevent the discharged liquid drop from invading adjacent display dot regions over the dividing components. As a result, it is possible to prevent the generation of a mixed color between the filter components formed in display dot regions adjacent to each other.

According to the method of manufacturing the electroluminescent substrate of the present invention, a plurality of liquid drops are preferably supplied to each of the plurality of display dot regions. In this case, the liquid drops are supplied such that their centers are situated within a distance that amounts to about 30% of the distance between the center of the display dot region and the edge of the display dot region closest to the center of the display dot region. Therefore, it is possible to supply a sufficient amount of light-emitting-element material to each display dot region and to prevent the generation of a mixed color between the display dot regions adjacent to each other.

Furthermore, according to the method of manufacturing the electroluminescent substrate of the present invention, the dividing components are preferably made of a lyophobic material. When the dividing component has a liquid repellent property, the probability of liquid drops going over the corresponding dividing component is small. Therefore, it is possible to prevent the generation of a mixed color between the display dot regions adjacent to each other.

According to the method of manufacturing the electroluminescent substrate of the present invention, when the length in the display dot region is L and the width is S, the following relationship holds between L and S.
0.7L≦S≦L

It is possible to uniformly disperse the light-emitting component material discharged to the corresponding display dot region in the corresponding display dot region by making the display dot region more square than long and narrow (rectangular or ellipsoidal) in plan view.

Furthermore, according to the method of manufacturing the electroluminescent substrate of the present invention, the display dot region is preferably circular or elliptical in plan view. Therefore, it is possible to uniformly disperse the discharged liquid material in the display dot region.

Moreover, according to the method of manufacturing the electroluminescent substrate, the plurality of display dot regions are preferably aligned in a delta arrangement. In the delta arrangement, each display dot region is more close to a square in plan view than in the stripe arrangement and the mosaic arrangement. Therefore, the delta arrangement is preferably used in order to uniformly disperse the liquid material in the display dot region.

In addition, a method of manufacturing an electro-optical device according to the present invention comprises a step of performing the aforementioned method of manufacturing the color filter substrate or the aforementioned method of manufacturing the electroluminescent substrate. According to the manufacturing method, it is possible to manufacture a high-quality electro-optical device capable of preventing the generation of mixed colors among a plurality of display dot regions.

An electro-optical device of the present invention is manufactured by the method of manufacturing the electro-optical device. According to the electro-optical device, it is possible to obtain filter components or light-emitting elements in which mixed colors are not generated between a plurality of display dot regions. Therefore, it is possible to perform clear color display. For example, a liquid crystal device composed of a color filter substrate and an electroluminescent device composed of an electroluminescent substrate may be used as the electro-optical device.

Furthermore, a method of manufacturing an electronic apparatus according to the present invention comprises a process of performing the above-mentioned method of manufacturing the electro-optical device. In addition, the electronic apparatus according to the present invention is manufactured by the method of manufacturing the electronic apparatus. For example, mobile telephones, portable information terminals, PDAs, and digital cameras may be used as the electronic apparatus.

### BRIEF DESCRIPTION OF THE DRAWINGS

FIGS. 1A-D illustrate the main processes of an embodiment of a method of manufacturing a color filter substrate according to the present invention.

FIGS. 2E-H continue from FIG. 1.

FIGS. 3I-K continue from FIG. 2. In particular, FIG. 3(k) illustrates an embodiment of a desired color filter substrate.

FIGS. 4A-C illustrate examples of arranging a plurality of filter components. FIG. 4A illustrates a stripe arrangement, FIG. 4B illustrates a mosaic arrangement, and FIG. 4C illustrates a delta arrangement.

FIG. 5 is a plan view illustrating an example of a liquid drop landing range when a liquid drop is discharged.

FIG. 6 is a cross-sectional view illustrating a cross section of a liquid crystal device that is an embodiment of an electro-optical device according to the present invention.

FIG. 7 is a perspective view illustrating an example of a manufacturing apparatus for performing the method of manufacturing the color filter substrate according to the present invention.

FIG. 8 is a circuit block diagram illustrating a controlling system of the manufacturing apparatus illustrated in FIG. 7.

FIG. 9 is a perspective view illustrating a material discharging portion of the manufacturing apparatus illustrated in FIG. 7.

FIG. 10 is a perspective view illustrating the internal structure of a main part of the material discharging portion illustrated in FIG. 9 with a part thereof cut out.

FIG. 11 is a cross-sectional view taken along the line D-D of FIG. 10.

FIGS. 12A-D illustrate the main processes of an embodiment of a method of manufacturing an electroluminescent substrate according to the present invention.

FIGS. 13E-H continue from FIG. 12.

FIGS. 14I-L continue from FIG. 13.

FIGS. 15M-O continue from FIG. 14.

FIGS. 16P-R continue from FIG. 15.

FIG. 17 is a cross-sectional view illustrating a cross section of one pixel of the electroluminescent device.

FIG. 18 is a circuit diagram illustrating an equivalent circuit of the electroluminescent device shown in FIG. 17.

FIG. 19 is a block diagram illustrating an embodiment of an electronic apparatus according to the present invention.

FIG. 20 illustrates a digital camera that is an embodiment of the electronic apparatus according to the present invention.

FIG. 21(a) describes conditions of an experiment according to the present invention, and FIG. 21(b) is a table illustrating the experiment results.

FIG. 22 is a graph illustrating the results of FIG. 21(b).

### DETAILED DESCRIPTION

Method of Manufacturing Color Filter Substrate

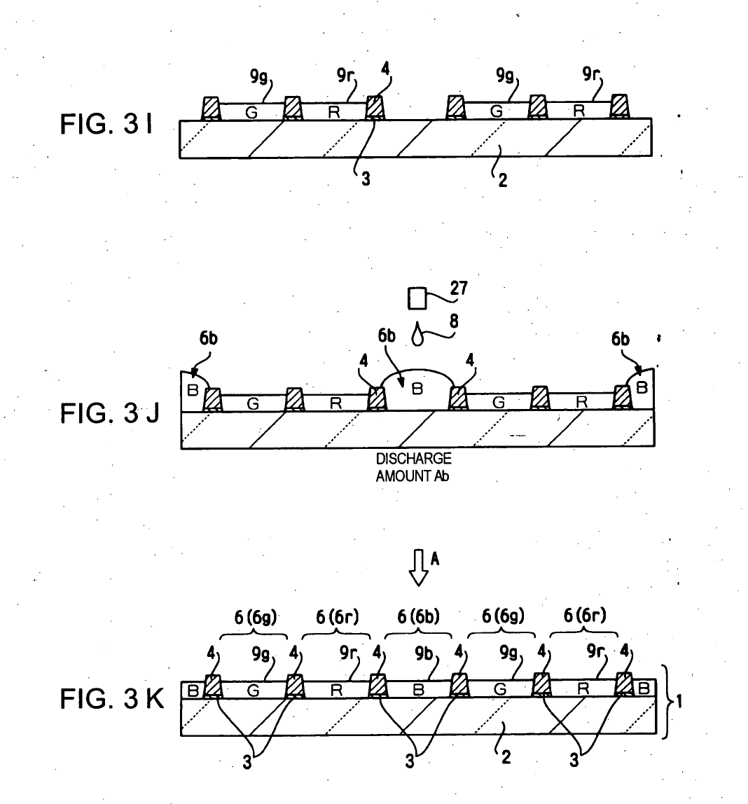

An embodiment of a method of manufacturing a color filter substrate according to the present invention will now be described; however, the present invention is not limited to this embodiment. The method of manufacturing the color filter substrate, which will now be described, is used for manufacturing a color filter substrate 1, as illustrated in FIG. 3(k).

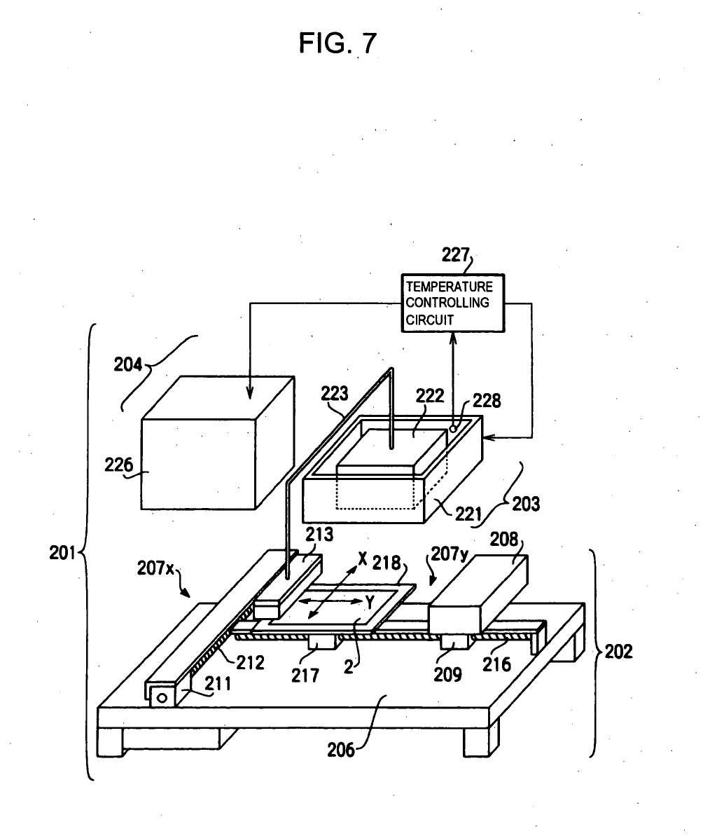

Prior to describing the method of manufacturing the color filter substrate, an apparatus for manufacturing the color filter substrate, by which the method of manufacturing the color filter substrate is realized, will now be simply described. FIG. 7 illustrates an example of such an apparatus for manufacturing the color filter substrate. A manufacturing apparatus 201 includes a filter forming unit 202, a filter material supplying unit 203, and a cooling preservation unit 204. The filter forming unit 202 includes a base 206, an X-direction driving system 207x provided on the base 206, and a Y-direction driving system 207y provided on the base 206.

The X-direction driving system 207x includes a driving motor 211 and a screw axis 212 driven by the driving motor 211 and rotating around the axis thereof. A recording head 213 is screw-engaged with the screw axis 212. When the screw axis 212 rotates in a clockwise or counterclockwise direction due to the operation of the driving motor 211, the recording head 213 screw-engaged with the screw axis 212 reciprocally moves in the direction of arrow X.

The Y-direction driving system 207y includes a screw axis 216 fixed to the base 206, a driving motor 217 for rotating an engaging member engaged with the screw axis 216, and a stage 218 fixed to the driving motor 217. A base member 2 of a color filter substrate that undergoes a filter forming process is mounted on the stage 218. In this case, the base member 2 is preferably fixed to the stage 218 so as not to have a positional error. When the engaging member rotates in the clockwise or counterclockwise direction due to the operation of the Y-direction motor 217, the stage 218 is guided by the screw axis 216 and reciprocally moves in the direction of arrow Y. The Y-direction is perpendicular to the X-direction.

A cleaning device 208 is provided on the screw axis 216 included in the Y-direction driving system 207y. The output axis of a motor 209 integrated with the cleaning device 208 is screw-engaged with the screw axis 216. When the cleaning device 208 is transferred to the recording head 213 by the operation of the motor 209, the recording head 213 may be cleaned by the cleaning device 208.

A heater 221 as a heating means is provided in the filter material supplying unit 203. A container 222 for storing the filter material may be placed in a space surrounded by the heater 221. The container 222 and the recording head 213 are connected to each other by a pipe 223. A liquid material in the container 222, that is, the filter material is supplied to the recording head 213 through the pipe 223.

According to the present embodiment, when color filters are formed to have three colors R, G, and B, three kinds of manufacturing apparatuses 201 for the colors R, G, and B are provided in different positions. A filter material corresponding to each of the colors R, G, and B is stored in the container 222 of each manufacturing apparatus 201.

The cooling preservation unit 204 is composed of a well-known refrigerator 226 using a refrigerant gas. The refrigerator 226 has at least a volume capable of storing the container 222. In addition, the container 222 can enter the refrigerator 226 through a door provided at an appropriate position of the refrigerator 226. The pipe 223 can be preferably released from the container 222 for the sake of operational convenience when the container is received.

The apparatus 201 for manufacturing the color filter substrate includes a temperature controlling circuit 227. The temperature controlling circuit 227 turns the refrigerator 226 on and off in accordance with the operation of an input device, such as a switch, by an operator. The temperature controlling circuit 227 controls the amount of current applied to the heater 221 in accordance with the information of the temperature in the container 222 measured by a temperature sensor 228 arranged around the container 222, that is, the information of the temperature of the filter material in the container 222. The calorific value of the heater 221 is controlled by controlling the amount of current to thus control the temperature of the filter material. According to the present embodiment, the temperature controlling circuit 227 raises the temperature of the filter material in the container 222 cooled by the refrigerator 226 to a service temperature, such as room temperature, for example, 18° C. to 26° C., preferably, 25° C. to 26° C. In addition, the refrigerator 226 may be independently turned on and off by an exclusive on/off switch as an operator desires.

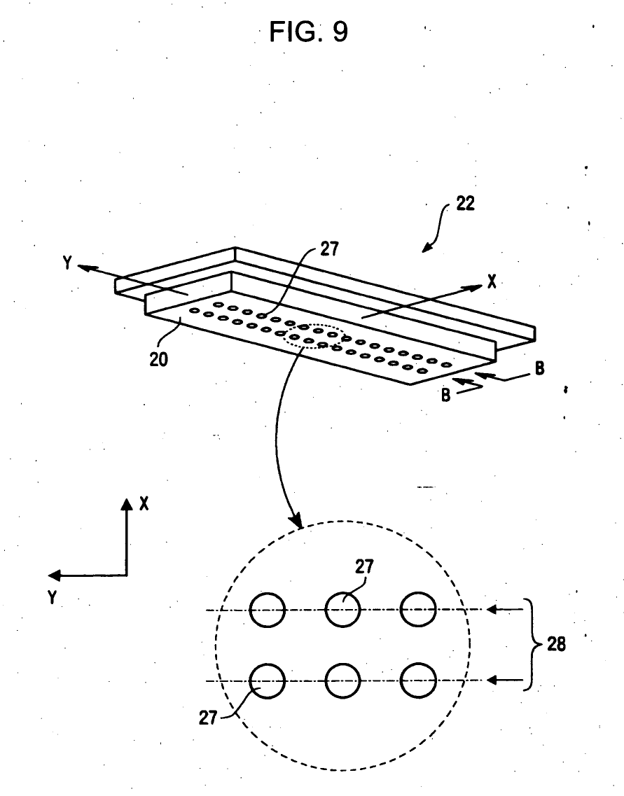

For example, one or a plurality of inkjet heads 22, illustrated in FIG. 9, are provided on the bottom surface of the recording head 213 constituting the filter forming unit 202 of FIG. 7. The inkjet head 22 includes a substantially rectangular casing 20 whose bottom surface is provided with a plurality of nozzles 27. Each of the nozzles 27 has a minute aperture having a diameter of about 0.02 mm to 0.1 mm.

According to the present embodiment, the plurality of nozzles 27 are provided in two rows to thus form two nozzle rows 28. In each nozzle row 28, the nozzles 27 are provided in a straight line so as to be separated from each other by a predetermined distance. Liquid, that is, the filter material is supplied to the nozzle rows 28 in the direction of arrow B. The supplied filter material is discharged from the nozzles 27 as minute liquid drops in accordance with the vibration of a piezoelectric element. The number of nozzle rows 28 may be one, or three or more.

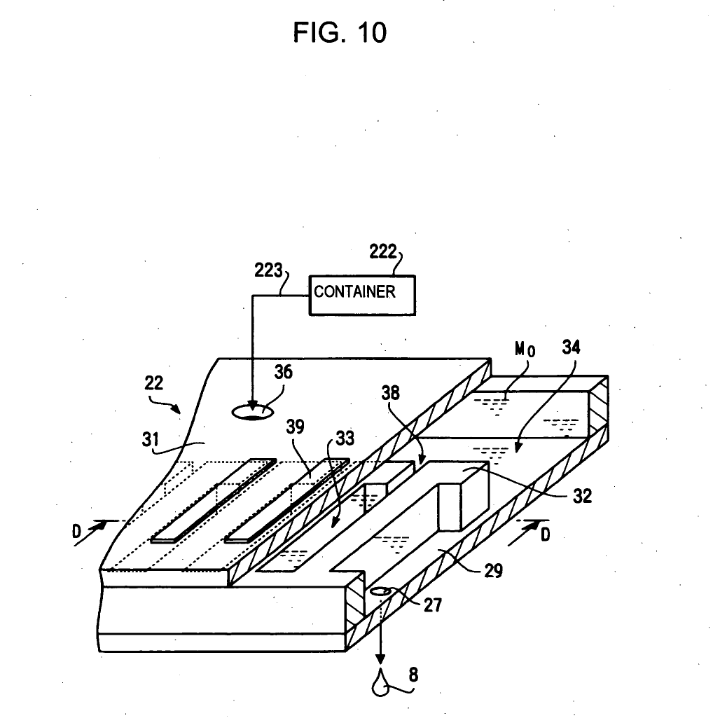

As illustrated in FIG. 10, the inkjet head 22 includes a nozzle plate 29 made of stainless steel, a vibration plate 31 arranged to face the nozzle plate 29, and a plurality of partitioning members 32 for connecting the nozzle plate 29 to the vibration plate 31. In addition, a plurality of storage chambers 33 for storing the filter material and a liquid storing portion 34 for temporarily storing the filter material are formed by the partitioning members 32 between the nozzle plate 29 and the vibration plate 31. Furthermore, the plurality of storage chambers 33 communicates with the liquid storing portion 34 through paths 38. A hole 36 for supplying the filter material is formed at an appropriate position of the vibration plate 31. The container 222 is connected to the supplying hole 36 through the pipe 223 illustrated in FIG. 7. The filter material M0 supplied from the container 222 is first filled in the liquid storage portion 34 and is then filled in the storage chambers 33 through the paths 38.

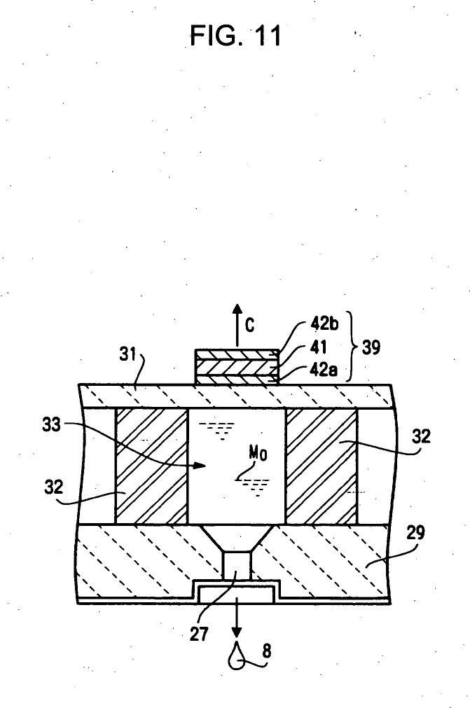

The nozzles 27 for spraying the filter material from the storage chambers 33 are provided in the nozzle plate 29 constituting a part of the inkjet head 22. It was previously described with reference to FIG. 9 that the nozzle rows 28 are formed by arranging the plurality of nozzles 27. Pressing members 39 for pressing the filter material are mounted on the surface of the vibration plate 31 that faces the storage chambers 33. As illustrated in FIG. 11, each of the pressing members 39 includes a piezoelectric element 41 and a pair of electrodes 42a and 42b between which the piezoelectric element 41 is sandwiched.

The piezoelectric element 41 is outwardly bent in the direction of arrow C when current is applied to the electrodes 42a and 42b thereby increasing the volumes of the storage chambers 33. When the volumes of the storage chambers 33 increase, the filter material M0 corresponding to the increased volumes flows from the liquid storage portion 34 into the storage chambers 33 through the paths 38.

When current is not applied to the piezoelectric element 41, the piezoelectric element 41 and the vibration plate 31 recover their original shapes, and the storage chambers 33 recover their original volumes. Therefore, the pressure to the filter material in the storage chambers 33 increases, and thus the filter material is discharged from the nozzles 27 as liquid drops 8. The liquid drops 8 are stably discharged from the nozzles 27 as minute liquid drops regardless of the kind of solvent included in the filter material.

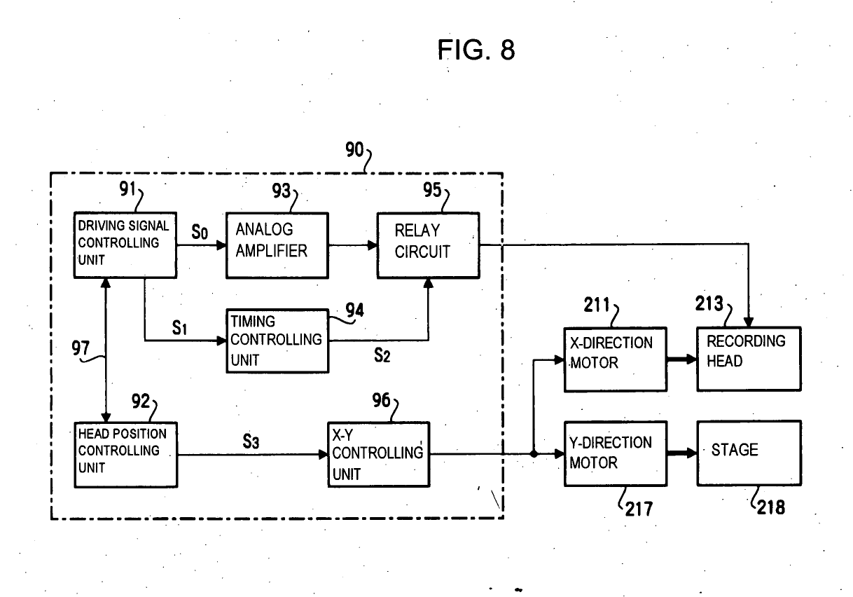

The apparatus 201 for manufacturing the color filter substrate includes a controlling device 90 illustrated in FIG. 8. The controlling device 90 controls the operation of the X-direction motor 211, the Y-direction motor 217, and the recording head 213 included in the filter forming unit 202 of FIG. 7. In addition, the manufacturing apparatus 201 also has a controlling unit for controlling the operation of the cleaning motor 209 shown in FIG. 7. However, a detailed description of the controlling unit will be omitted.

The controlling device 90 includes a driving signal controlling unit 91 composed of a computer and a head position controlling unit 92 composed of a computer. The driving signal controlling unit 91 and the head position controlling unit 92 can share information through a signal line 97. The driving signal controlling unit 91 outputs a waveform S0 for driving the recording head 213 to an analog amplifier 93. In addition, the driving signal controlling unit 91 outputs to a timing controlling unit 94 bit map data S1 representing the positions to which the filter material is discharged.

The analog amplifier 93 amplifies the waveform S0 and transfers the amplified waveform S0 to a relay circuit 95. The timing controlling unit 94, in which a clock pulse circuit is provided, outputs a discharge timing signal S2 to the relay circuit 95 in accordance with the bit map data S1. The relay circuit 95 outputs the waveform S0 transferred from the analog amplifier 93 to the input port of the recording head 213 in accordance with the discharge timing signal S2 transferred from the timing controlling unit 94.

The head position controlling unit 92 outputs information S3 on the position of the recording head 213 to an X-Y controlling circuit 96. The X-Y controlling-circuit 96 outputs a signal for controlling the position of the recording head 213 in the X-direction to the X-direction motor 211 and outputs a signal for controlling the position of the stage 218 in the Y-direction to the Y-direction motor 217, based on the transferred information S3 on the position of the recording head 213.

In accordance with the above-mentioned structures of the driving signal controlling unit 91 and the head position controlling unit 92, when the recording head 213 is located at the desired coordinates on the base member 2 mounted on the stage 218, the recording head 213 discharges the filter material as liquid drops thereto. As a result, the liquid drops of the filter material are applied to the desired positions on the base member 2.

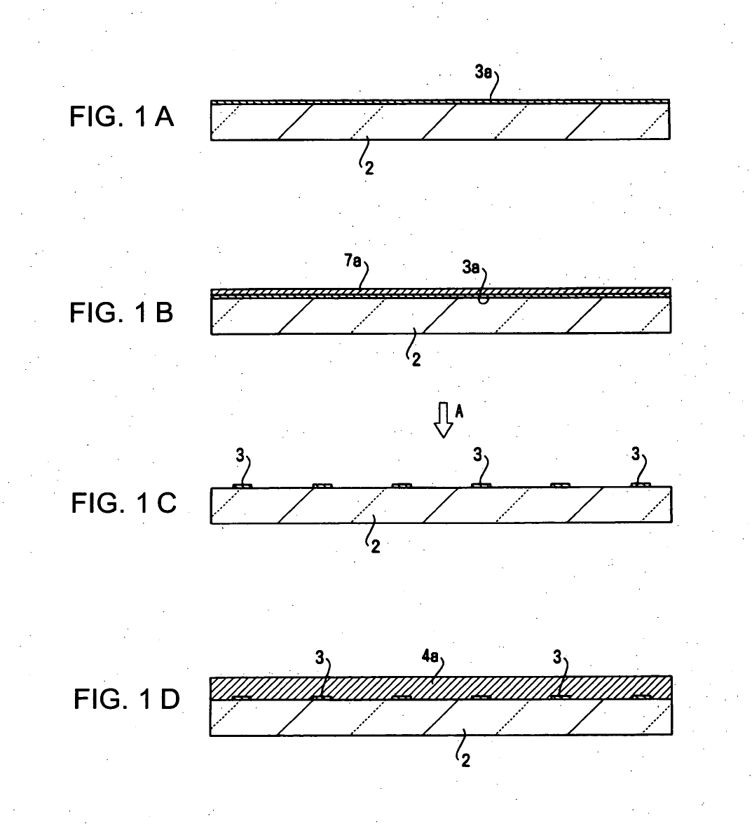

A method of manufacturing a color filter substrate, in which the inkjet head 22 illustrated in FIG. 9 is used, will now be described. In FIGS. 1 to 3, processes of performing such a manufacturing method are sequentially illustrated. FIG. 3(k) illustrates a desired color filter substrate 1.

In FIG. 1(a), a metal thin film 3a is formed on the base member 2, which is made of transmissive glass and plastic, by a dry plating method using materials for forming a light shielding layer 3 such as Cr, Ni, and Al. In this case, the thickness of the metal thin film 3a is preferably about 0.1 to 0.5 μm.

Next, as shown in FIG. 1(b), a resist 7a that is a photosensitive resin is applied with a uniform thickness. The resist 7a is exposed with a mask covering it and is then developed to thus form the resist 7a of a predetermined pattern. Subsequently, the light shielding layer 3 in a predetermined shape, that is, in a lattice shape as seen from the arrow A, is formed as illustrated in FIG. 1(c) by etching the metal thin film 3a using the resist pattern as a mask.

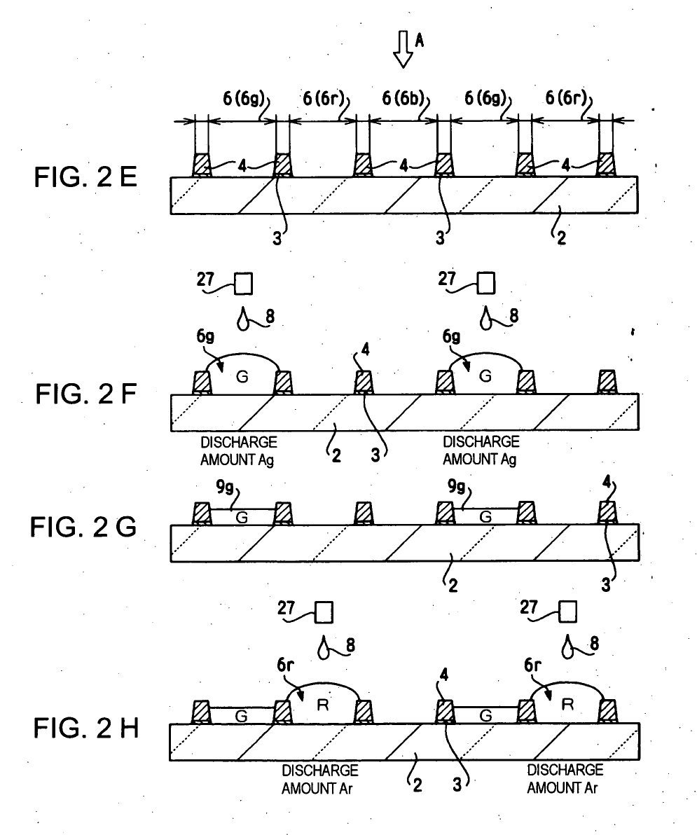

In FIG. 1(d), photosensitive resin 4a is formed on the light shielding layer 3 with a uniform thickness, and a photolithography process is performed thereon. As a result, as illustrated in FIG. 2(e), banks 4 of a predetermined pattern are formed in the same shape as that of the light shielding layer 3, that is, in a lattice shape. At this time, the height of the bank 4 is preferably about 1.0 μm.

A plurality of display dot regions 6 divided by the banks 4 is formed on the base member 2 by forming the banks 4 as mentioned above. The plurality of display dot regions 6 are arranged in a matrix as seen from the direction of the arrow A since the banks 4 are formed in a lattice shape. Furthermore, it is not necessary to make the banks 4 black, and urethane-based or acryl-based hardened photosensitive resin compositions may be used for the banks 4.

The main role of the banks 4 is to store the filter material in the display dot regions 6. The filter material is preferably not attached to the surfaces of the banks 4. Therefore, the material of the banks 4 preferably has the property of repelling the filter material, that is, a lyophobic property. Therefore, the banks 4 are preferably made of fluorine resin, silicon resin, and the like.

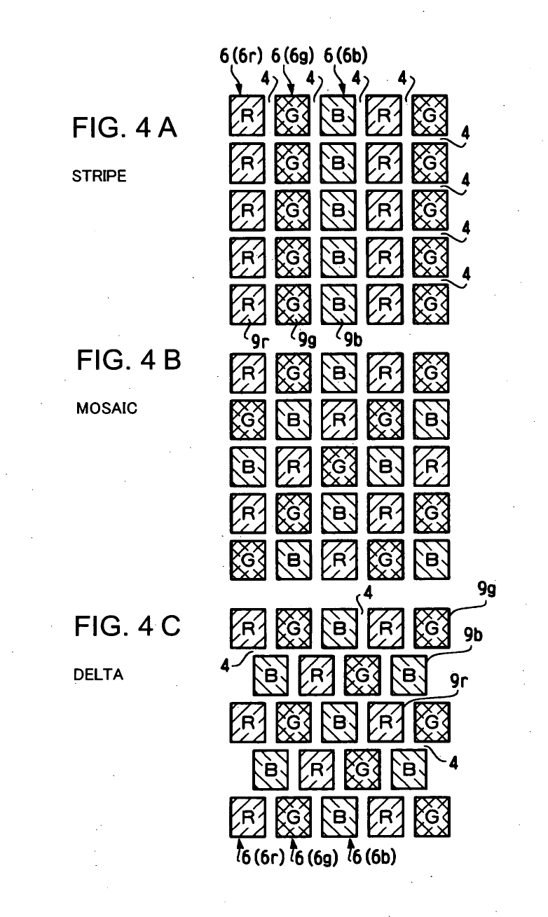

As mentioned above, after forming the banks 4 on the base member 2, the base member 2 is mounted at a predetermined position on the stage 218 of FIG. 7. Next, the X-direction driving system 207x and the Y-direction. driving system 207y are operated, and the pressing members 39 shown in FIG. 10 are operated to thus perform the following color filter forming processes. According to the present embodiment, as illustrated in FIG. 4(c), G color filter components 9g, R color filter components 9r, and B color filter components 9b are aligned in a delta arrangement. In the delta arrangement, the filter components of the colors R, G, and B are arranged at positions corresponding to the apexes of a triangle and are sequentially and repeatedly arranged in the row direction.

In FIG. 4, in addition to the delta arrangement, a stripe arrangement is illustrated in FIG. 4(a), and a mosaic arrangement is illustrated in FIG. 4(b). In the stripe arrangement, each of the colors R, G, and B is arranged in the column direction, and the colors R, G, and B are repeatedly arranged in this order in the row direction. In the mosaic arrangement, the colors R, G, and B are repeatedly arranged in this order in the column and row directions. In FIG. 4, the shapes of the filter components 9g, 9r, and 9b in each arrangement are the same for the sake of convenience. However, actually, the filter components are long and narrow in the stripe arrangement and in the mosaic arrangement while they are close to a square in the delta arrangement.

In the color filter forming process, as shown in FIG. 2(f), the filter material of the color G is discharged as the liquid drops 8 into display dot regions 6g, in which the filter components of the color G are to be formed, by the inkjet head 22 illustrated in FIG. 9. The liquid drops 8 are discharged into one display dot region several times. The total amount Ag of the discharged liquid drops is previously set to be larger than the volume of the display dot regions 6g, which is defined by the height of the banks 4. Therefore, the discharged filter material of the color G protrudes above the banks 4. Then, the solvent included in the filter material of the color G is evaporated by heating the filter material of the color G at a temperature of 50° C. for ten minutes to thus pre-bake the filter material of the color G. As a result, the surface of the filter material of the color G is planarized as illustrated in FIG. 2(g), thereby forming the filter components 9g of the color G.

Next, in FIG. 2(h), the filter material of the color R is discharged as the liquid drops 8 into display dot regions 6r, in which the filter components of the color R are to be formed, by the inkjet head 22 illustrated in FIG. 9. The total amount Ar of the discharged liquid drops is also set to be larger than the volume of the display dot regions 6r, which is defined by the height of the banks 4. The discharged filter material of the color R protrudes above the banks 4. Then, the solvent included in the filter material of the color R is evaporated by heating the filter material of the color R at a temperature of 50° C. for ten minutes to thus pre-bake the filter material of the color R. As a result, the surface of the filter material of the color R is planarized as illustrated in FIG. 3(i), thereby forming the filter components 9r of the color R.

Next, in FIG. 3(j), the filter material of the color B is discharged as the liquid drops 8 into display dot regions 6b, in which the filter components of the color B are to be formed, by the inkjet head 22 illustrated in FIG. 9. The total amount Ab of the discharged liquid drops is also set to be larger than the volume of the display dot regions 6b, which is defined by the height of the bank 4. The discharged filter material of the color R protrudes above the banks 4. Then, the solvent included in the filter material of the color B is evaporated by heating the filter material of the color B at a temperature of 50° C. for ten minutes to thus pre-bake the filter material of the color B. As a result, the surface of the filter material of the color B is planarized as illustrated in FIG. 3(k), thereby forming the filter components 9b of the color B.

Subsequently, the filter components are hardened by heating them, for example, at a temperature of 230° C. for thirty minutes to thus post-bake the filter components. As a result, the color filter, in which the filter components 9g, 9r, and 9b of the colors R, G, and B are aligned in a predetermined arrangement, for example, in the delta arrangement illustrated in FIG. 4(c), is formed. At the same time, the color filter substrate 1 composed of the base member 2 and the color filter is formed.

The apparatus 201 for manufacturing the color filter substrate illustrated in FIG. 7 performs the above-mentioned color filter substrate forming process. While the color filter substrate forming process is performed, the container 222 that stores the filter materials of the colors R, G, and B is arranged in the filter material supplying unit 203. Then, the filter materials are transferred to the recording head 213 through the pipe 223. At this time, when the temperature of the filter materials is the service temperature, that is, room temperature, for example, 18° C. to 26° C., and preferably 25° C. to 26° C., the heater 221 does not generate heat.

When the period of time until the manufacturing apparatus 201 is operated again after the color filter substrate forming process is terminated is long, a worker takes the container 222 including the filter material out of the filter material supplying unit 203 and puts it in the refrigerator 226 in the cooling preservation unit 204. The temperature inside the refrigerator 226 is set to be lower than the service temperature of the filter materials or the deterioration temperature of the filter materials. When the service temperature, that is, room temperature is set to 25° C. to 26° C., the temperature inside the refrigerator 226 is set to about 10° C. Therefore, the filter materials put in the refrigerator 226 are stored in a refrigerated state at a temperature of 10° C. As a result, it is possible to prevent the filter materials from deteriorating in a short time and to maintain the quality of the filter materials for a long time.

As mentioned above, in a case where the filter materials are refrigerated and stored in the refrigerator 226, when the filter materials are taken out of the refrigerator 226 to resume the filter substrate forming process, it is not possible to start the filter substrate forming process until the temperature of the filter materials taken out of the refrigerator 226 rises to the service temperature, that is, room temperature. According to the present embodiment, since the heater 221 is provided in the filter material supplying unit 203, it is possible to raise the temperature of the filter materials in the container 222 to the service temperature in a short time when the worker makes the heater 221 generate heat by placing the container 222 in a region surrounded by the heater 221. Therefore, it is possible to restart the filter substrate forming process using the inkjet head 22 (see FIG. 9) in a short time.

When there is some time left until the filter material forming process restarts, it is possible to naturally raise the temperature of the filter materials in a room-temperature environment without generating heat using the heater 221.

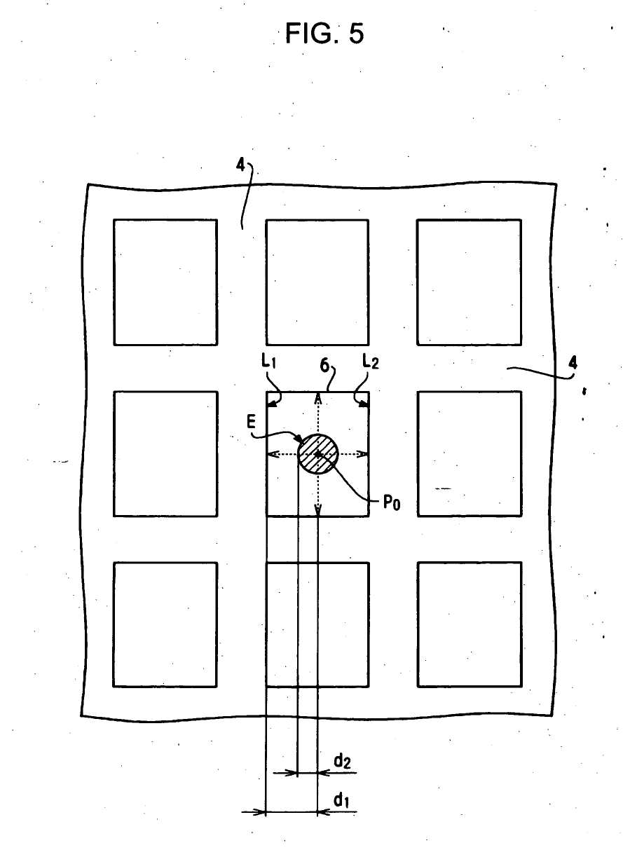

According to the present embodiment, in the filter material discharging process illustrated in FIGS. 2 and 3, the landing position of the liquid drop 8 to the display dot region 6 is set to a position as illustrated in FIG. 5. To be specific, the center of the liquid drop 8 of the filter material is controlled to be within the shaded liquid drop landing range E. The liquid drop landing range E is determined as follows. That is, in the display dot region 6, an intersection P0 between a line that passes through the central point in the direction of the length and a line that passes through the central point in the direction of the width is determined as the center of the liquid drop landing range E. A circular region whose diameter is a distance that amounts to about 30% of the distance between the center P0 and the edge of the display dot region 6 closest to the center P0, that is, a distance d2 that amounts to about 30% of the distance d1 between the center P0 and a side L1 or L2 of the display dot region 6, in the case of FIG. 5, is determined as the liquid drop landing range E. It is possible to prevent the discharged liquid drop from invading other adjacent display dot regions 6 over the banks 4 by limiting the landing position of the liquid drop to the range E and to thus prevent the generation of a mixed color between adjacent filter components.

As mentioned above, according to the present embodiment, a liquid drop lands at the center of the display dot region 6. Therefore, when the display dot region 6 is excessively long and narrow in plan view, there is some fear that the filter material may not spread widely around the ends of longitudinal sides of the display dot region 6. In order to prevent the occurrence of such a phenomenon, the display dot region 6 is more preferably close to square or circular instead of long and narrow (rectangular or ellipsoidal) in plan view.

The inventor of the present invention performed an experiment on the above. As a result, the inventor found that it is possible to uniformly spread the filter material over almost the entire display dot region 6 such that the filter material can be practically used when the relationship 0.7 L≦S≦L holds between the length L and the width S of the display dot region 6.

Modification

According to the above embodiment, the three colors R, G, and B are used for the filter components that constitute color filters. However, the colors C (cyan), M (magenta), and Y (yellow) may be used for the filter components in addition to the colors R, G, and B.

According to the above embodiment, the filter components 9g, 9r, and 9b are aligned in the delta arrangement illustrated in FIG. 4(c). However, the stripe arrangement illustrated in FIG. 4(a) or the mosaic arrangement illustrated in FIG. 4(b) may be adopted instead of the delta arrangement.

Furthermore, according to the above embodiment, as illustrated in FIG. 5, the display dot region 6 is rectangular in plan view. However, the display dot region 6 may be circular or elliptic in plan view. Since circles or ellipses have no edges unlike rectangles or squares, the display dot region is preferably circular or elliptic when it is considered to uniformly spread the filter material over the entire display dot region.

First Embodiment of Electro-Optical Device and Method of Manufacturing the Same

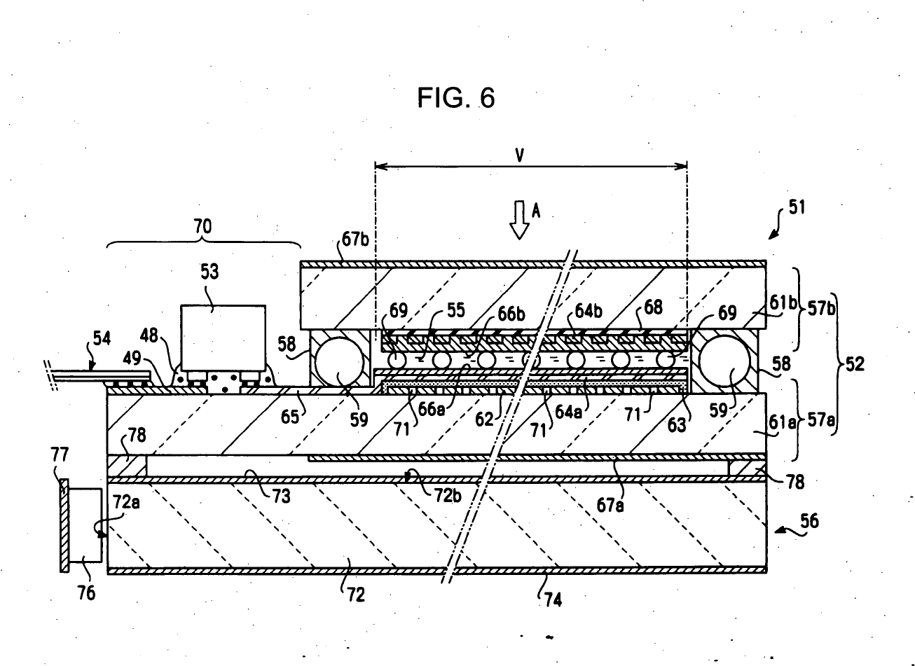

An embodiment of an electro-optical device according to the present invention will now be described with reference to a liquid crystal device that is an example of the electro-optical device. The present invention is not, of course, limited to this embodiment. FIG. 6 illustrates a transflective liquid crystal device, as an embodiment of a liquid crystal device, in which reflective display and transmissive display are selectively performed and a simple matrix method where switching elements are not used is employed.

A liquid crystal device 51 illustrated in FIG. 6 is formed by providing an illuminating device 56 and a wiring line substrate 54 to a liquid crystal panel 52. The liquid crystal panel 52 is formed by attaching a first substrate 57a that is rectangular or square as seen from the direction of the arrow A to a second substrate 57b that is rectangular or square as seen from the direction of the arrow A using a sealing material 58 in a ring shape as seen from the direction of the arrow A.

A gap referred to as a cell gap is formed between the first substrate 57a and the second substrate 57b. Liquid crystal is injected into the cell gap to thus form a liquid crystal layer 55. Reference numeral 69 denotes spacers for maintaining the cell gap. In addition, an observer observes the liquid crystal device 51 in the direction of the arrow A.

The first substrate 57a includes a first base member 61a composed of transmissive glass or transmissive plastic. A reflecting film 62 is formed on the surface of the first base member 61a on the liquid crystal layer side. An insulating film 63 is formed on the reflecting film 62. First electrodes 64a are formed on the insulating film 63. An alignment film 66a is formed on the first electrodes 64a. A first polarizer 67a adheres to the surface of the first base member 61a opposite to the illuminating device 56.

A second substrate 57b facing the first substrate 57a includes a second base member 61b composed of transmissive glass or transmissive plastic. A color filter 68 is formed on the surface of the second base member 61b on the side of the liquid crystal. Second electrodes 64b are formed on the color filter 68. An alignment film 66b is formed on the second electrodes 64b. A second polarizer 67b adheres to the outer surface of the second base member 61b.

The first electrodes 64a on the first substrate 57a are linear electrodes extending from side to side in FIG. 6. The plurality of first electrodes 64a are arranged to be parallel to each other in a direction vertical to the sheet. In short, the plurality of first electrodes 64a are formed in a stripe shape as seen from the direction of the arrow A.

The second electrodes 64b on the second substrate 57b are linear electrodes extending in a direction vertical to the sheet in FIG. 6. The plurality of second electrodes 64b are arranged to be parallel to each other from side to side in FIG. 6. In short, the plurality of second electrodes 64b are formed in a stripe shape extending in a direction orthogonal to the first electrodes 64a.

The first electrodes 64a intersect the second electrodes 64b at the points arranged in a matrix as seen from the direction of the arrow A. The intersections constitute dot regions for display. When color display is performed using color filters composed of filter components of the three colors R, G, and B or C, M, and Y, each of the three colors corresponds to each of the display dot regions, and one unit composed of a set of the three colors forms one pixel. An effective display region V is formed by arranging a plurality of pixels in a matrix as seen from the direction of the arrow A. Images, such as characters, numbers, and figures, are displayed in the effective display region V.

Apertures 71 are formed in the reflecting film 62 so as to correspond to the display dot regions that are the minimum units of display. Planar light emitted from the illuminating device 56 passes through the apertures 71, thereby realizing transmissive display. In addition, the transmissive display may be realized by making the reflecting film 62 thin as well as by providing the apertures 71 in the reflecting film 62.

The first base member 61a includes a protruding portion 70 that protrudes from the edge of the second base member 61b. The first electrodes 64a on the first substrate 57a cross the sealing materials 58 and extend onto the protruding portion 70 to thus become a wiring line 65. Furthermore, external connection terminals 49 are formed at the edge of the protruding portion 70. A wiring line substrate 54 is electrically connected to the external connection terminals 49. The second electrodes 64b on the second substrate 57b are connected to the wiring line 65 on the first substrate 57a through conductive materials 59 dispersed in the sealing material 58. In addition, the conductive materials 59 are illustrated to have almost the same width as that of the sealing material 58 in FIG. 6. However, the width of the conductive materials 59 is actually smaller than that of the sealing material 58. Therefore, the plurality of conductive materials 59 commonly exist in the direction of the width of the sealing material 58.

A driving IC 53 adheres between the wiring line 65 and the external connection terminals 49 by an anisotropic conductive film (ACF) 48 on the surface of the protruding portion 70. The bumps of the driving IC 53 are electrically connected to the wiring line 65 and the external connection terminals 49 by the ACF 48. With such a mounting structure, signals and voltage are supplied from the wiring line substrate 54 to the driving IC 53. In addition, scanning signals and data signals from the driving IC 53 are transmitted to the first electrodes 64a or the second electrodes 64b.

In FIG. 6, the illuminating device 56 is provided on the rear surface of the liquid crystal panel 52 as seen from an observer with a buffer material 78 interposed therebetween and functions as a backlight. The illuminating device 56 includes a light emitting diode (LED) 76 as a light source supported by a substrate 77 and a light guiding body 72. A diffuser sheet 73 is provided on the surface of the light guiding body 72 on the side of the observer. A reflector sheet 74 is provided on a surface opposite thereto. The light emitted from the LED 76, as a point light source, is incident into the light guiding body 72 through a light receiving surface 72a of the light guiding body 72 and becomes planar light while traveling through the light guiding body 72, and then the planar light is emitted from a light emitting surface 72b.

When reflective display is performed in the liquid crystal device 51 having the above structure, external light, such as sun light and indoor light, is incident into the liquid crystal layer 55 through the second substrate 57b, is reflected from the reflecting film 62, and is supplied to the liquid crystal layer 55 again. Meanwhile, when transmissive display is performed, the LED 76 of the illuminating device 56 emits light, planar light is emitted from the light emitting surface 72b of the light guiding body 72, and the light is supplied to the liquid crystal layer 55 through the plurality of apertures 71 provided in the reflecting film 62.

In a case where light is supplied to the liquid crystal layer 55, when scanning signals are supplied to either the first electrodes 64a or the second electrodes 64b and data signals are supplied to the other one, a predetermined voltage is applied to display dots to which the corresponding data signals are supplied. Therefore, liquid crystal is driven, and the light supplied to the corresponding display dots is modulated. Such modulation is performed in each display dot in the effective display region V, that is, in each pixel. Desired images, such as characters, numbers, and figures, are formed in the effective display region V and are observed by an observer from the direction of the arrow A.

The liquid crystal device 51 according to the present embodiment is characterized in that a color filter 68 included therein is manufactured by the method of manufacturing the color filter substrate illustrated in FIGS. 1 to 5 using the apparatus for manufacturing the color filter substrate illustrated in FIGS. 7 to 11. According to the manufacturing method illustrated in FIGS. 1 to 5, as described with reference to FIG. 5, it is possible to prevent the liquid drop discharged in one display dot region 6 from invading other adjacent display dot regions and thus to prevent the generation of a mixed color. Therefore, the liquid crystal device 51 manufactured by the method of manufacturing the liquid crystal device, in which the manufacturing method is used as one process, has a high-quality color filter 68 to thus perform clear and high-quality color display.

Modification

According to the embodiment of FIG. 6, the present invention is applied to a transflective liquid crystal device in a simple matrix. However, the present invention can be applied to various liquid crystal devices, such as a transflective liquid crystal device in a simple matrix, which does not have a reflective display function, a reflective liquid crystal device in a simple matrix, which does not have a transmissive display function, an active matrix liquid crystal device using two terminal switching elements such as thin film diodes (TFDs), and an active matrix liquid crystal device using three terminal switching elements such as thin film transistors (TFTs).

Second Embodiment of Electro-Optical Device and Method of Manufacturing the Same

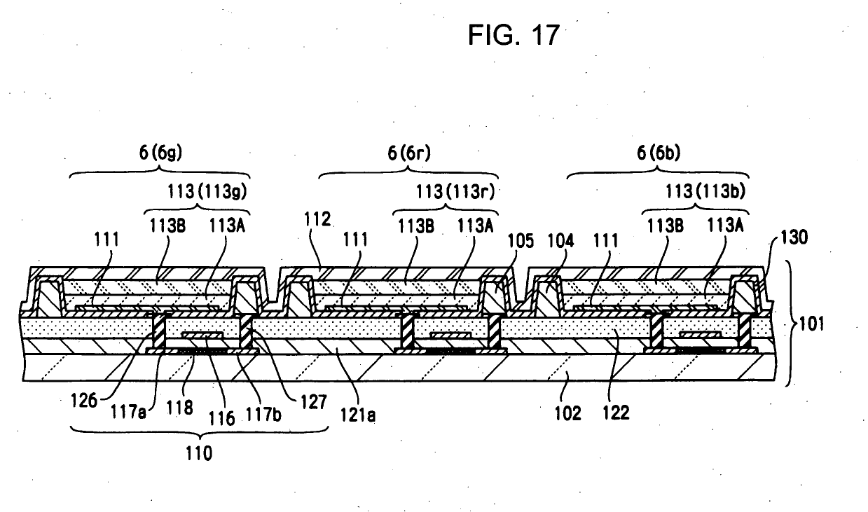

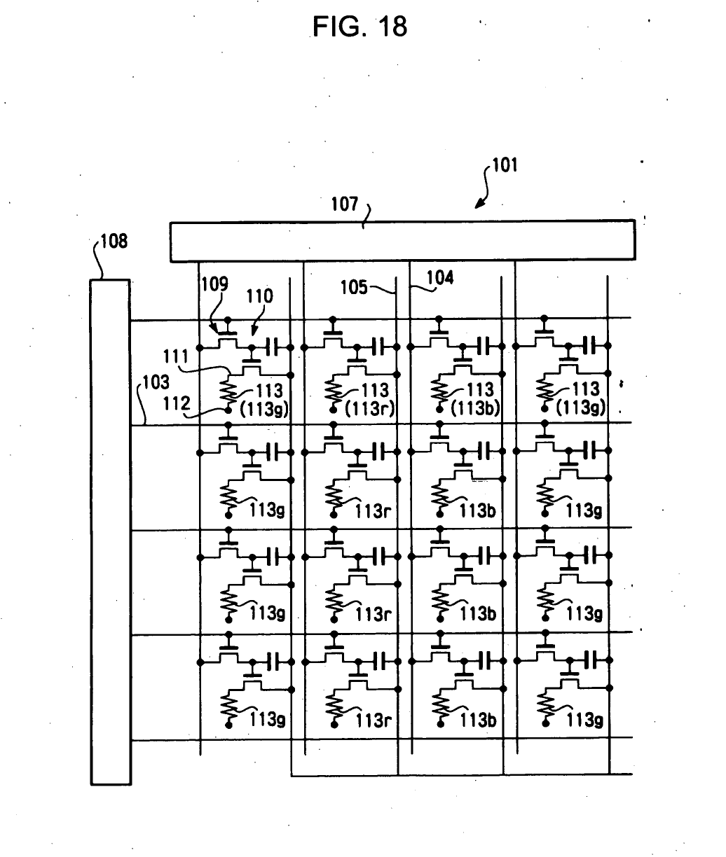

FIG. 18 illustrates an embodiment of the electric structure of an EL device according to an embodiment of an electro-optical device in accordance with the present invention. FIG. 17 illustrates a cross section of a part of a mechanical structure corresponding to the electric structure. Also, in the present specification, an EL substrate is a structure in which EL elements are formed on a substrate. The EL device is an electro-optical device in which a reflecting electrode or other optical components are provided on the EL substrate.

In FIG. 18, an EL device 101 includes a driving IC 107 for outputting data signals and a driving IC 108 for outputting scanning signals. The driving IC 107 outputs data signals to a plurality of signal lines 104. The driving IC 108 outputs scanning signals to a plurality of scanning lines 103. The scanning lines 103 and the signal lines 104 cross each other at a plurality of portions. Display dot regions constituting pixels are formed at the intersections. FIG. 17 illustrates a display dot region 6g of the color G, a display dot region 6r of the color R, and a display dot region 6b of the color B. Each display dot region includes one of the EL elements of the three colors R, G, and B. The display dot regions corresponding to the three colors R, G, and B constitute one pixel.

In FIG. 18, one display dot region includes a switching thin film transistor 109, a current thin film transistor 110, a pixel electrode 111, a reflecting electrode 112, and an EL element 113. In the EL element 113, an EL element 113g that emits light of the color G, an EL element 113r that emits light of the color R, and an EL element 113b that emits light of the color B are aligned in a predetermined arrangement, for example, in a delta arrangement. In FIG. 17, each EL element 113 is formed by stacking an organic semiconductor film 113B on a hole injecting layer 113A that is a lower layer. Furthermore, in FIG. 17, the current thin film transistors 110 are illustrated, however, the switching thin film transistors 109 that exist in another section are not illustrated.

In FIG. 17, when an appropriate display dot region is selected from among the plurality of display dot regions 6 and a predetermined voltage is applied between the pixel electrode 111 and the reflecting electrode 112 therein, the EL element 113 in the corresponding display dot region 6-emits light and images such as characters, numbers, and figures are color displayed on the outside (that is, on the bottom side of FIG. 17) of the base member 102.

The EL device 101 according to the present embodiment is characterized in that the EL elements 113 included therein are manufactured by a method of manufacturing an EL substrate according to the present invention as described below. According to the method of manufacturing the EL substrate of the present invention, as mentioned below, when an EL light-emitting material is discharged as liquid drops by an inkjet technology, that is, a liquid drop discharging technology, the landing positions of liquid drops are controlled to be in the specific ranges within the display dot regions 6, and it is possible to prevent the EL light-emitting material from invading adjacent display dot regions 6 and to thus prevent the generation of a mixed color between different EL light-emitting materials. Therefore, the EL device illustrated in FIGS. 17 and 18, which is manufactured by the method of manufacturing the EL substrate, has an EL element with no mixed color to thus perform clear and high-quality color display.

Method of Manufacturing Electroluminescent Substrate

A method of manufacturing an EL substrate according to the present invention will now be described with reference to a case where the EL substrate used for the EL device illustrated in FIGS. 17 and 18 is manufactured. Also, the present invention is not limited to the embodiment.

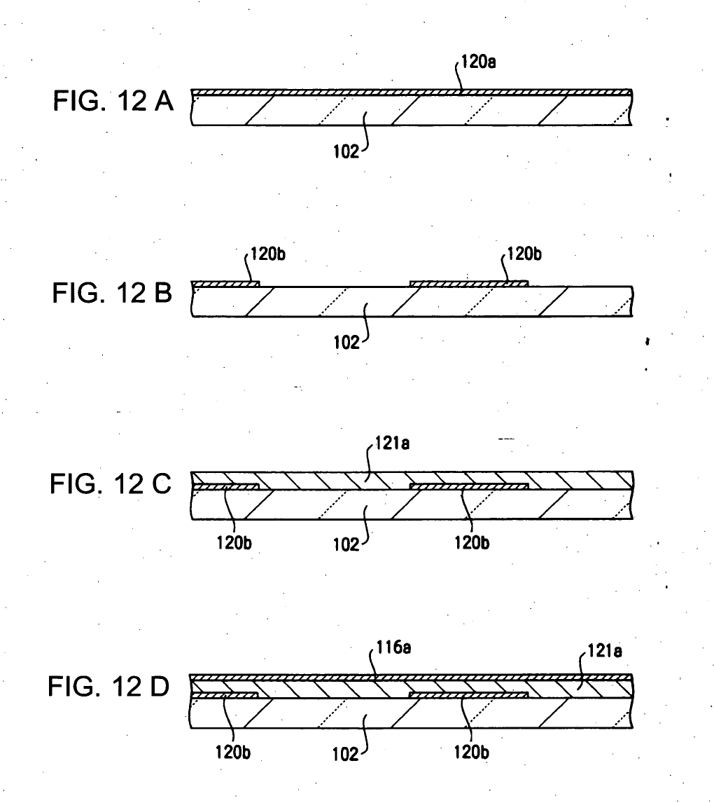

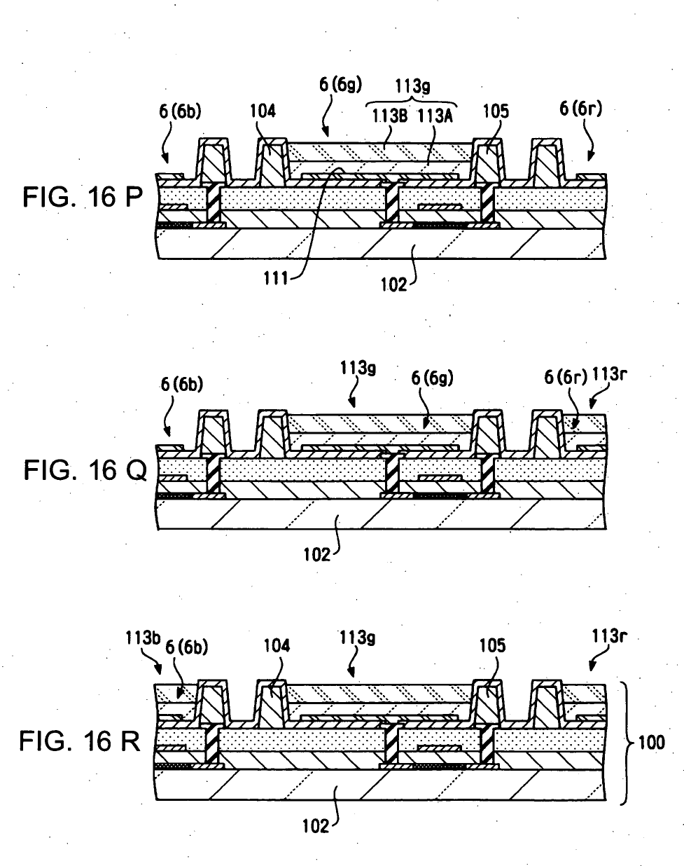

FIGS. 12 to 16 illustrate an embodiment of the method of manufacturing the EL substrate in the order of processes. The manufacturing method is used for manufacturing the EL substrate 100 illustrated in FIG. 16(r). When the EL substrate 100 is manufactured, in FIG. 12(a), a base protecting layer (not shown) composed of a silicon oxide film is formed on a transmissive base member 102 by a plasma chemical vapor deposition (CVD) method using tetraethoxysilane (TEOS) or oxygen gas as a source gas, preferably, to a thickness of about 2,000 to 5,000 Å.

Next, the temperature of the base member 102 is set to about 350° C. and a semiconductor film 120a that is an amorphous silicon film is formed on the surface of the base member by the plasma CVD method to a thickness of about 300 to 700 Å. Then, a crystallizing process, such as a laser anneal or a solid state growth method is performed on the semiconductor film 120a to crystallize the semiconductor film 120a into a polysilicon film.

Next, a resist film is formed on the semiconductor film 120a, and a resist mask is formed by exposing and developing the resist film. Then, the semiconductor film 120a is patterned using the resist mask. As a result, insular semiconductor films 120b illustrated in FIG. 12(b) are formed.

Next, as illustrated in FIG. 12(c), a gate insulating film 121a composed of a silicon oxide film or a nitride film is formed on the surfaces of the base member 102 in which the semiconductor films 120b are formed, by the plasma CVD method using TEOS or oxygen gas as a source gas, preferably, to a thickness of about 600 to 1,500 Å. The semiconductor films 120b become a channel region and source and drain regions of the current thin film transistor 110 (see FIG. 18). In another section, semiconductor films (not illustrated) that are a channel region and a source and drain regions of the switching thin film transistor 109 (see FIG. 18) are also formed. According to the manufacturing-processes illustrated in FIGS. 12 to 16, since two kinds of switching thin film transistors and current thin film transistors are formed at the same time and in the same order, only the process of forming the current thin film transistor 110 will now be described, and a description of the process of forming the switching thin film transistor will be omitted.

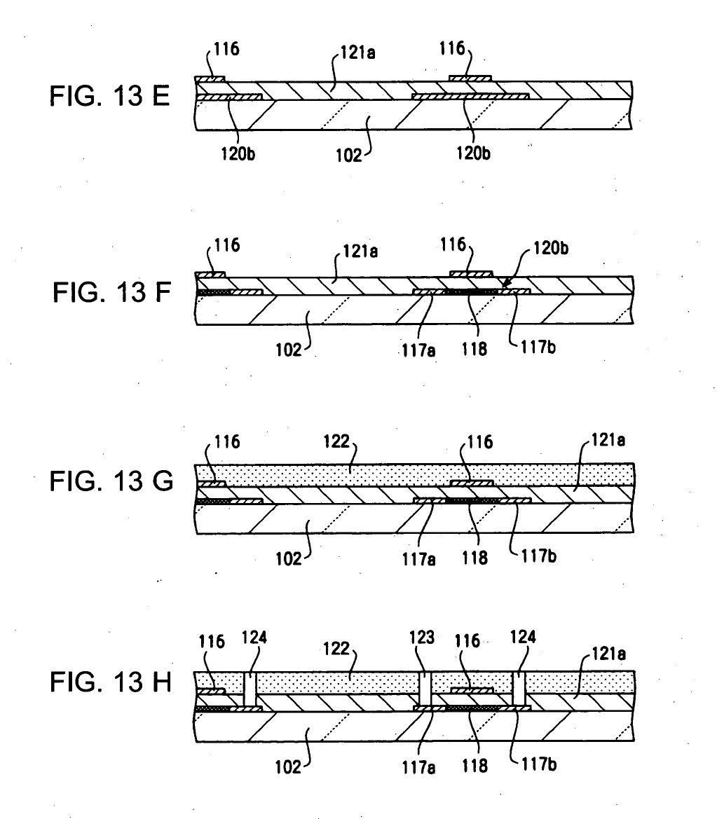

Next, in FIG. 12(d), a conductive film 116a is formed of Al or Ta by a sputtering method. Then, the conductive film 116a is coated with a resist material, and a resist mask is formed by exposing and developing the resist material. The conductive film 116a is patterned using the resist mask to form gate electrodes 116 as illustrated in FIG. 13(e).

In this state, impurities such as high temperature phosphorus ions are injected. As a result, as illustrated in FIG. 13(f), source and drain regions 117a and 117b are self-aligned in the semiconductor films 120b with respect to the gate electrodes 116. Furthermore, the portions into which the impurities are not injected become channel regions 118.

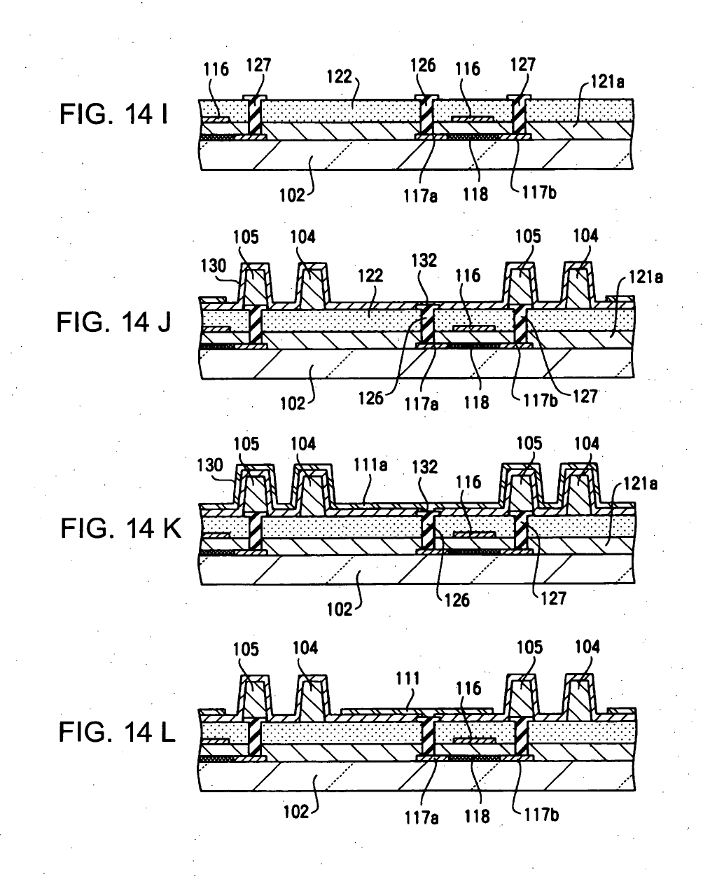

Next, in FIG. 13(g), an interlayer insulating film 122 is formed. Then, in FIG. 13(h), contact holes 123 and 124 are formed. In addition, as illustrated in FIG. 14(i), relay electrodes 126 and 127 are formed by filling a conductive material into the contact holes 123 and 124.

Furthermore, as illustrated in FIG. 14(i), signal lines 104, common power supply lines 105, and scanning lines 103 (see FIG. 18) are formed on the interlayer insulating film 122. Next, an interlayer insulating film 130 is formed so as to cover the top surfaces of the, respective wiring lines, and a contact hole 132 is formed at a position corresponding to the relay electrode 126. And then, in FIG. 14(k), an indium tin oxide (ITO) film 111a is formed so as to fill the contact hole 132. Subsequently, the ITO film 111a is coated with resist, and a resist mask is formed by exposing and developing the resist. The ITO film 111a is patterned using the resist mask. As a result, as illustrated in FIG. 14(l), a pixel electrode 111 electrically connected to the source and drain regions 117a are formed in the region surrounded by the signal line 104, the common power supply line 105, and the scanning line 103.

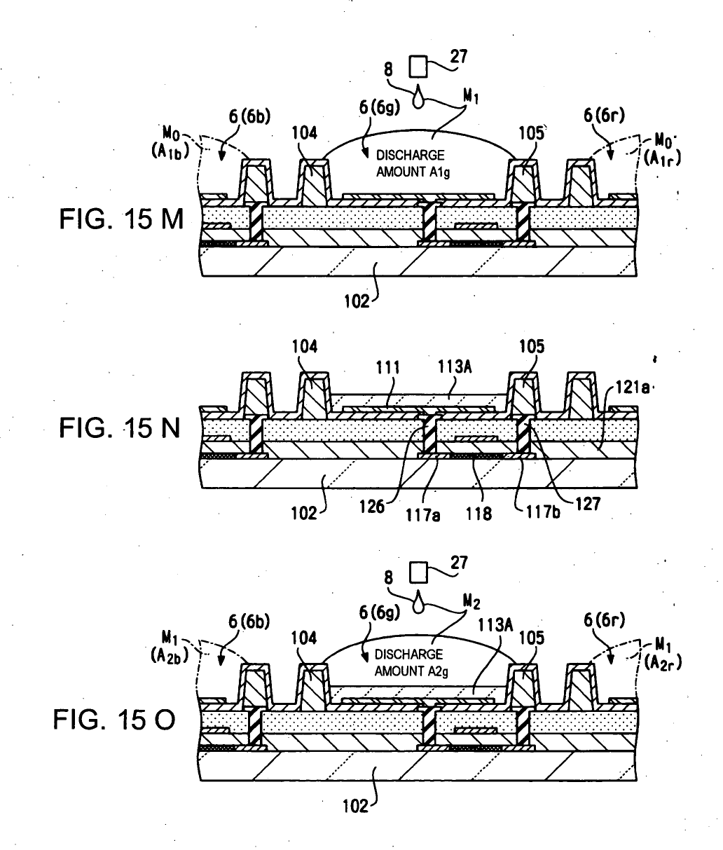

Next, as illustrated in FIGS. 15(m) to 16(r), EL elements are formed on the base member 102 using the inkjet head 22 illustrated in FIG. 9. In this case, in FIG. 15(m), the signal line 104, the common power supply line 105, and the scanning line 103 shown in FIG. 18 operate as dividing components, and the plurality of display dot regions 6 are formed on the base member 102. In addition, in FIG. 15(m), the region, in which the light-emitting element of the color G is formed, is denoted by 6g, and the region, in which the light-emitting element of the color R is formed, is denoted by 6r. Furthermore, the region, in which the light-emitting element of the color B is formed, is denoted by 6b.

First, in a state where the surface of the base member 102 faces the upper direction, a material Ml for forming a hole injecting layer 113A corresponding to the lower layer of the EL element 113g of FIG. 17 is discharged from the nozzle 27 of the inkjet head 22 of FIG. 9 as liquid drops and is selectively supplied to the first region surrounded by the dividing components 103, 104, and 105, that is, the region 6g of the color G. As a result, the region 6g is coated with the material M1.

At this time, the discharge amount A1g is previously set to be larger than the volume of the display dot region 6g, which is defined by the height of the dividing components 103, 104, and 105. The supplied light-emitting-element material of the color G protrudes above the dividing components 103, 104, and 105. Then, the solvent included in the material M1 is evaporated by heating, that is, pre-baking or the irradiation of light. As a result, as illustrated in FIG. 15(n), the hole injecting layer 113A having the flat surface is formed. When the thickness of the hole injecting layer 113A is smaller than the desired thickness, a process of discharging and supplying the material M1 is repeated.

Next, as illustrated in FIG. 15(o), in a state where the surface of the base member 102 faces in the upper direction, an organic semiconductor film material M2 for forming an organic semiconductor film 113B on the upper layer of the EL element 113g shown in FIG. 17 is discharged from the nozzle 27 of the inkjet head 22 shown in FIG. 9 as liquid drops and is selectively applied in the first region surrounded by the dividing components 103, 104, and 105, that is, in the region 6g of the color G. The organic semiconductor film material M2 is preferably an organic fluorescent material dissolved in a solvent.

At this time, the discharge amount A2g is previously set to be larger than the volume of the display dot region 6g, which is defined by the height of the dividing components 103, 104, and 105. The supplied organic semiconductor film material M2 protrudes above the dividing components 103, 104, and 105. Next, the solvent included in the material M2 is evaporated by heating, that is, pre-baking or the irradiation of light. As a result, as illustrated in FIG. 16(p), the organic semiconductor film 113B having a flat surface is formed on the hole injecting layer 113A. When the thickness of the organic-semiconductor film 113B is smaller than the desired thickness, a process of discharging the material M2 is repeated. In this manner, the EL element 113g for emitting the light of color G is formed by the hole injecting layer 113A and the organic semiconductor film 113B.

Next, in FIG. 16(p), the processes illustrated in FIGS. 15(m) to 16(p) are repeatedly performed on the region 6r of the color R that is the second display dot region to thus form the EL element 113r that emits the light of the color R in the region 6r of the color R as illustrated in FIG. 16(q). In FIG. 16(q), after the EL element 113r of the color R is formed, the processes illustrated in FIGS. 15(m) to 16(p) are repeatedly performed on the region 6b of the color B that is the third display dot region to thus form the EL element 113b that emits the light of the color B in the region 6b of the color B as illustrated in FIG. 16(r).

As mentioned above, the EL elements 113g, 113r, and 113b of the colors G, R, and B are formed in FIG. 16(r) to thus manufacture an electroluminescent substrate. Thereafter, as illustrated in FIG. 17, a reflecting electrode 112 is formed on the entire surface of the base member 102 or on the stripe region, on which the EL elements 113g, 113r, and 113b are formed, for example, by a photolithography process and an etching process. If necessary, other electronic components are provided. As a result, the electroluminescent device 101 is manufactured. In the electroluminescent device 101, one of the plurality of display dot regions 6 that are arranged in a matrix is selected and a voltage is applied between the pixel electrode 111 and the reflecting electrode 112 thereof to thus let the EL elements 113g, 113r, and 113b selectively emit light. As a result, it is possible to display images, such as characters, numbers, and figures, on the base member 102.

According to the present embodiment, in the process of discharging the light-emitting-element material as illustrated in FIG. 15, the landing position of the liquid drop 8 to the respective display dot regions 6 are set to the position illustrated in FIG. 5. To be specific, the landing position of the liquid drop 8 of the light-emitting-element material is controlled such that the center thereof is situated within the shaded liquid drop landing range E. The liquid drop landing range E is determined as follows: that is, in the display dot region 6, an intersection P0 between the line that passes through the central point in the direction of the length and the line that passes through the central point in the direction of the width is determined as the center of the liquid drop landing range E. The circular region whose radius is a distance that amounts to about 30% of the distance between the center P0 and the edge of the display dot region 6 closest to the center P0, that is, a distance d2 that amounts to about 30% of the distance d1 between a side L1 or a side L2 and the center P0 as shown in FIG. 5 is determined as the liquid drop landing range E. In other words, the central 30% of the region as determined relative to the shortest width of the region. It is possible to prevent the discharged liquid drop from invading adjacent display dot regions 6 over the banks 4 by limiting the landing position of the liquid drop to the range E, thereby preventing the generation of a mixed color between the adjacent light-emitting elements.

Electronic Apparatus and Method of Manufacturing the Same

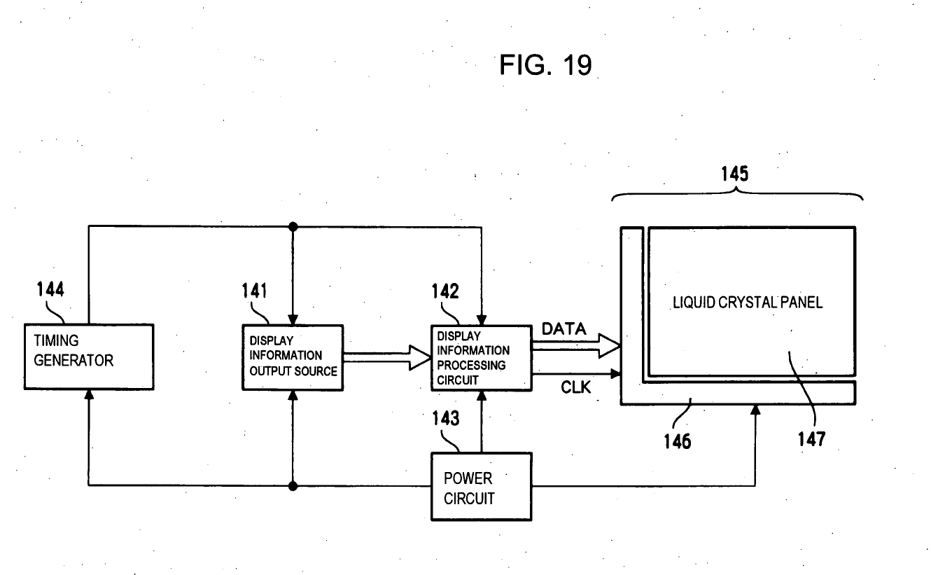

FIG. 19 illustrates an embodiment of an electronic apparatus according to the present invention. The electronic apparatus shown in FIG. 19 includes a display information output source 141, a display information processing circuit 142, a power circuit 143, a timing generator 144, and a liquid crystal device 145. The liquid crystal device 145 includes a liquid crystal panel 147 and a driving circuit 146. The liquid crystal device 51 illustrated in FIG. 6, which is manufactured by the manufacturing method illustrated in FIGS. 1 to 5 using the apparatus for manufacturing the color filter substrate illustrated in FIGS. 7 to 11, can be used as the liquid crystal device 145.

The display information output source 141 that includes a memory such as a random access memory (RAM), a storage unit such as a disk, and a resonance circuit for synchronously outputting digital image signals supplies display information such as image signals of a predetermined format to the display information processing circuit 142 based on various clock signals generated from the timing generator 144.

In addition, the display information processing circuit 142 that includes a plurality of well-known circuits such as an amplifying and inverting circuit, a rotation circuit, a gamma correcting circuit, and a clamp circuit processes input display information and supplies the image signals to the driving circuit 146 together with clock signals CLK. Herein, a test circuit together with a scanning line driving circuit (not illustrated) and a data line driving circuit (not illustrated) are generically named as the driving circuit 146. Furthermore, the power circuit 143 supplies a predetermined voltage to the respective components.

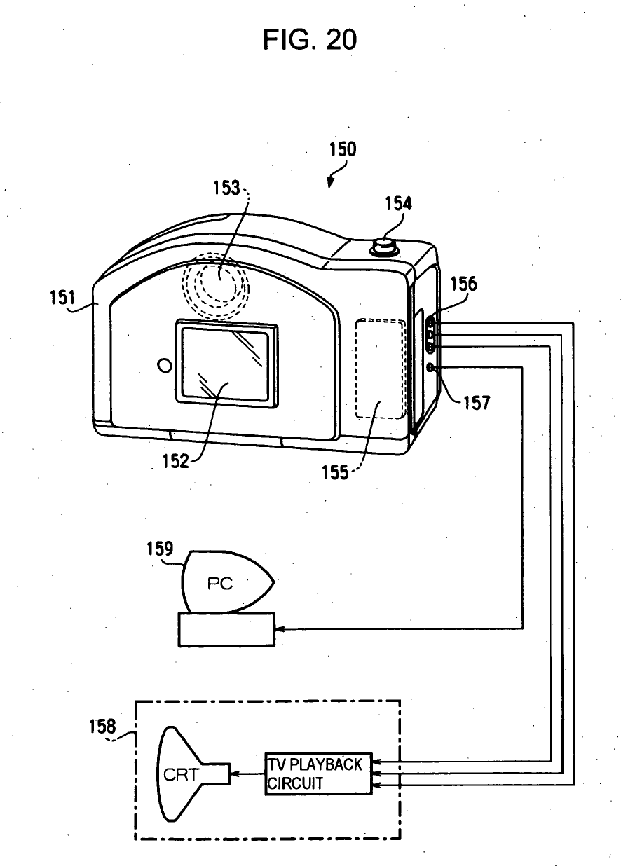

FIG. 20 illustrates a digital camera that is another embodiment of the electronic apparatus according to the present invention, in which the liquid crystal device is used as a finder. In the digital camera 150, a liquid crystal display unit 152 is provided on the rear surface of a case 151. The liquid crystal display unit 152 functions as a finder for displaying a subject. The liquid crystal display unit 152 may be composed of the liquid crystal device 51 illustrated in FIG. 6, which is manufactured by the manufacturing method illustrated in FIGS. 1 to 5 using the apparatus for manufacturing the color filter substrate illustrated in FIGS. 7 to 11.

A light receiving unit 153 including an optical lens or a charge coupled device (CCD) is provided on the front surface (on the back surface in FIG. 20) of the case 151. When a photographer recognizes a subject displayed on the liquid crystal display unit 152 and presses a shutter 154, a photographing signal of the CCD at that point of time is transmitted to a memory of a circuit substrate 155 and is stored therein.

A video signal output terminal 156 and a data communication input and output terminals 157 are provided on the side of the case 151. A television monitor 158 may be connected to the video signal output terminal 156 if necessary, and a personal computer 159 may be connected to the data communication input and output terminals 157 if necessary. The photographing signals stored in the memory of the circuit substrate 155 are output to the television monitor 158 or the personal computer 159 by a predetermined manipulation.

Other Embodiments

The present invention has been described with reference to the above-mentioned preferred embodiments. However, the present invention is not limited to the preferred embodiments, and various modifications may be made without departing from the spirit and scope of the invention as defined by the appended claims.

Experimental Embodiment

An experiment performed by the present inventors will now be described. In the experiment, the inventors examined at which position of one display dot region the liquid drop should be discharged from the nozzle of the inkjet head in order to reduce the generation of a mixed color.

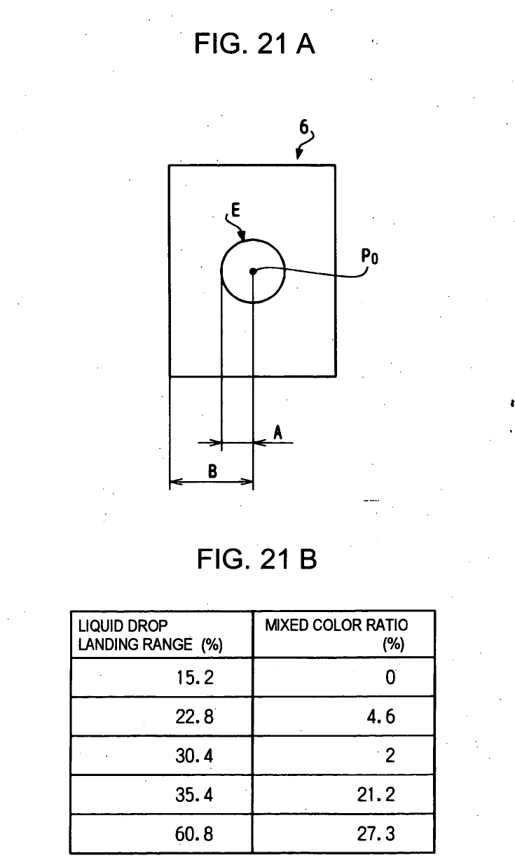

According to the present experiment, in FIG. 21(a), when the distance between the center P0 and the edge of one display dot region 6 closest to the center P0 is ‘B’ and the radius of the liquid drop landing range ‘E’ is ‘A’, the size of the liquid drop landing range E to the display dot region 6 can be represented by the following Equation 1.
(the length of A/the length of B)×100(%) (1)

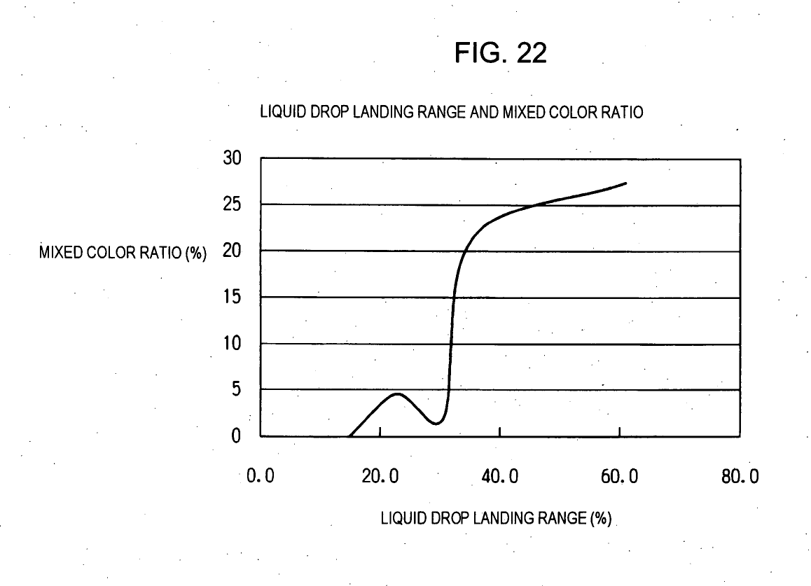

Five kinds of liquid drop landing ranges, such as 15.2%, 22.8%, 30.4%, 35.4%, and 60.8%, are set as illustrated in the table of FIG. 21(b) based on Equation 1. The degree of generation of a mixed color in the respective liquid drop landing ranges is determined in percentage based on the determination that results from the direct view. Consequently, the results are represented in the item of the mixed color ratio of the table shown in FIG. 21(b). Also, the results are represented in FIG. 22 as a graph.

According to the graph shown in FIG. 22, the mixed color ratio increases when the liquid drop landing range is larger than 30%. From the above result, it is possible to prevent the generation of the mixed color when the liquid drop landing range is limited to be within 30%.

1. A method of manufacturing a color filter substrate, the method comprising:
a step of forming dividing components dividing a base member into a plurality of display dot regions; and
a material discharging step of discharging a liquid filter material from a liquid drop discharging portion to the plurality of display dot regions as liquid drops,
wherein, in the material discharging step, the liquid drops of the filter material are discharged such that a center of each liquid drop is situated within about 30% of a distance between a center of the display dot region and an edge of the display dot region closest to the center of the display dot region.

2. The method of manufacturing a color filter substrate according to claim 1,
wherein a plurality of liquid drops are supplied to each of the plurality of display dot regions such that the center of each of the plurality of liquid drops is situated within about 30% of the distance between the center of the display dot region and the edge of the display dot region closest to the center of the display dot region.

3. The method of manufacturing a color filter substrate according to claim 1,
wherein the liquid drops entirely cover the display dot regions.

4. The method of manufacturing a color filter substrate according to claim 1,
wherein the dividing components further comprise a lyophobic material.

5. The method of manufacturing a color filter substrate according to claim 1,
wherein, when a length of the display dot region is L and a width of the display dot region is S, 0.7 L≦S≦L.

6. The method of manufacturing a color filter substrate according to claim 1,
wherein the display dot region further comprises one of a circular region and an elliptical region in plan view.

7. The method of manufacturing a color filter substrate according to claim 1,
wherein the filter components formed in the plurality of display dot regions are aligned in a delta arrangement.

8. A method of manufacturing an electroluminescent substrate, the method comprising:
a step of forming dividing components for dividing a base member into a plurality of display dot regions; and
a material discharging step of discharging a liquid light-emitting component material from a liquid drop discharging portion to the plurality of display dot regions as liquid drops,
wherein, in the material discharging step, the liquid drops of the filter material are discharged such that a center of each liquid drop is situated within about 30% of a distance between a center of the display dot region and an edge of the display dot region closest to the center of the display dot region.

9. The method of manufacturing an electroluminescent substrate according to claim 8,
wherein a plurality of liquid drops are supplied to each of the plurality of display dot regions such that the center of each of the plurality of liquid drops is situated within about 30% of the distance between the center of the display dot region and the edge of the display dot region closest to the center of the display dot region.

10. The method of manufacturing an electroluminescent substrate according to claim 8,
wherein the liquid drops entirely cover the display dot regions.

11. The method of manufacturing an electroluminescent substrate according to claim 8,
wherein the dividing components further comprise a lyophobic material.

12. The method of manufacturing an electroluminescent substrate according to claim 8,
wherein, when a length of the display dot region is L and a width of the display dot region is S, 0.7L≦S≦L.

13. The method of manufacturing an electroluminescent substrate according to claim 8,
wherein the display dot region further comprises one of a circular region and an elliptical region in plan view.

14. The method of manufacturing an electroluminescent substrate according to claim 8,
wherein the light-emitting elements formed in the plurality of display dot regions are aligned in a delta arrangement.

15. The method of manufacturing an electro-optical device, the method comprising a process of performing the method of manufacturing a color filter substrate according to claim 1.

16. The method of manufacturing an electro-optical device, the method comprising a process of performing the method of manufacturing an electroluminescent substrate according to claim 8.

17. The electro-optical device manufactured by the method of manufacturing an electro-optical device according to claim 15.

18. The method of manufacturing an electronic apparatus, the method comprising a process of performing the method of manufacturing an electro-optical device according to claim 15.

19. The electronic apparatus manufactured by the method of manufacturing an electronic apparatus according to claim 18.
